(19) United States
(12) Patent Application Publication
(10) Pub. No.: US 2013/0344963 A1
(43) Pub. Date: Dec. 26, 2013

(54) MULTIPLAYER SYNCHRONOUS GAMING SYSTEMS AND METHODS

(71) Applicants: Diwakar Gupta, Seattle, WA (US); Michael Shim, Seattle, WA (US); Chih-Jen Huang, Issaquah, WA (US); Derek Gaw, Seattle, WA (US); Ivann Alvarado, San Francisco, CA (US); Jason Paul Allen, Seattle, WA (US)

(72) Inventors: Diwakar Gupta, Seattle, WA (US); Michael Shim, Seattle, WA (US); Chih-Jen Huang, Issaquah, WA (US); Derek Gaw, Seattle, WA (US); Ivann Alvarado, San Francisco, CA (US); Jason Paul Allen, Seattle, WA (US)

(21) Appl. No.: 13/924,255

(22) Filed: Jun. 21, 2013

Related U.S. Application Data
(60) Provisional application No. 61/663,463, filed on Jun. 22, 2012.

(51) Int. Cl. A63F 13/00

(52) U.S. Cl. CPC A63F 13/00
USPC 463/40

(57) ABSTRACT

A system, computer-readable storage medium storing at least one program, and a computer-implemented method for providing synchronous multiplayer games are presented. To begin, an enabling request for multiplayer functionality in a multiplayer instance that includes a single player mode game is received. The single player mode game may involve a game board dedicated to a first player. Then, the single player mode game of the multiplayer instance is matched with additional multiplayer instances. Each additional multiplayer instance includes a corresponding single player mode game dedicated to a respective player. The single player mode games from the multiplayer instance and the additional multiplayer instances are then instructed to initiate gameplay at substantially the same time. Final scores from the single player mode games from the multiplayer instance and the additional multiplayer instances are collected. A game summary page is finally communicated to the first player and the respective players.

### CROSS-REFERENCE TO RELATED APPLICATIONS

This application claims priority from U.S. Provisional Appl. No. 61/663,463, filed Jun. 22, 2012, all of which is incorporated herein by reference in its entirety for all purposes.

### TECHNICAL FIELD

The present disclosure relates to games and applications in general and, in particular embodiments, to multiplayer synchronous games.

### BACKGROUND

Many traditional online games may offer a synchronous multiplayer game mode where a server hosts an instance of a game board or virtual environment. When players join the multiplayer game using the instance of the game board or the virtual environment, the game server may include data or logic that updates the game board or virtual environment to include a presentation of the joining player. As more players join the multiplayer game, the game server further updates the game board or virtual environment to also include a representation of these joining players. Thus, in traditional synchronous online games, the game board or virtual environment may be shared by each of the players that joined the multiplayer game. As a result, traditional synchronous online games may include game or logic that synchronizes the game board or virtual environment responsive to game actions performed by each player.

### BRIEF DESCRIPTION OF THE DRAWINGS

The present disclosure is illustrated by way of example, and not limitation, in the figures of the accompanying drawings, in which like reference numerals indicate similar elements unless otherwise indicated.

FIG. 1 illustrates an example of a system for implementing various disclosed embodiments.

FIG. 2 illustrates an example social network, according to an example embodiment.

FIG. 3 illustrates an example of a system for implementing multiplayer games, according to an example embodiment.

FIG. 4 is a flow diagram illustrating an example method for implementing a multiplayer game, according to an example embodiment.

FIG. 5 is a flow diagram illustrating an example method for managing multiple client systems involved in a multiplayer game, according to an example embodiment.

FIGS. 6-14 illustrate example user interfaces enabling a display of, and interaction with, various aspects of a multiplayer game, according to example embodiments.

FIG. 15 illustrates an example data flow in a system, according to an example embodiment.

FIG. 16 illustrates an example network environment, according to an example embodiment.

FIG. 17 illustrates an example computing system architecture, according to an example embodiment.

### DESCRIPTION OF EXAMPLE EMBODIMENTS

### Brief Overview

Example systems and methods of utilizing a synchronous game framework are described. In the following description, for purposes of explanation, numerous specific details are set forth in order to provide a thorough understanding of example embodiments. It will be evident, however, to one skilled in the art that the described systems and methods may be practiced without these specific details.

The systems and methods described herein allow multiple users to compete in a game at substantially the same time. In some embodiments, games that are traditionally single player mode games are offered as multiplayer synchronous games with a specific time period for play, such as 60 seconds. As described herein, multiple players participate in the same game during a specified time period. Each of the multiple players is playing on a separate system (e.g., their own computing device), and playing on their own game board (also referred to as a “game environment”). As used herein, “synchronous games” begin at substantially the same time. Since each of the multiple players is using a separate system, the actual start time of the multiple games may vary by a few seconds. However, regardless of the actual start time of the multiple games, each player has the same length of time to play the game.

During the game play, a “leader board” is displayed to all game players. The leader board shows other players competing in the current game as well as information regarding the other players, such as player name, player avatar, player score, recent game activities, recent game awards, and chat messages. The ordering of the leader board is updated during the game, as needed, to represent the current ranking of the players based on score (current highest scoring player on top) or other parameter. At the end of the game, a final ranking and score for each player is displayed. Players are also given an opportunity to play another game with the same group of players. Additionally, a particular player can add other players in the previous game to a “game friends” list, thereby expanding the player's social gaming network.

Accordingly, a system, computer-readable storage medium storing at least one program, and a computer-implemented method for providing synchronous multiplayer games are presented. To begin, an enabling request for multiplayer functionality in a multiplayer instance that includes a single player mode game is received. The single player mode game may involve a game board dedicated to a first player. Then, the single player mode game of the multiplayer instance is matched with additional multiplayer instances. Each additional multiplayer instance includes a corresponding single player mode game dedicated to a respective player. The single player mode games from the multiplayer instance and the additional multiplayer instances are then instructed to initiate gameplay at substantially the same time. Final scores from the single player mode games from the multiplayer instance and the additional multiplayer instances are collected. A game summary page is finally communicated to the first player and the respective players.

For clarity of description, a single player mode game may refer to a game that limits gameplay to a single player, as may be accomplished by providing a game board dedicated to the single player. As such, during gameplay of the single player mode game, the challenges presented to and game actions performed by the individual player are isolated to the single player mode game. Further, a multiplayer instance may refer to data or logic container that wraps or interfaces with a single player mode game such that the single player mode game is enabled for multiplayer games. Such may be accomplished by synchronizing the start of gameplay and tracking and providing status updates regarding the scores of competing players playing separate single player mode games. It is to be appreciated that each player, as may be represented by a multiplayer instance, operates on their corresponding single player mode game. It is to be further appreciated that the game instance, whole or in part, may operate on a server, the client, or some combination thereof.

In some cases, example embodiments may be used to provide multiplayer functionality to games that have been built lacking such capabilities. For example, a game may be deployed in which only one player may play at a time. Any competition among players would normally be accomplished by rotating turns among players or by comparing scores after the game have been played. However, some embodiment described herein, may allow game developers to take a game title that was originally developed to play in single player mode and provide multiplayer mode without substantial augmentation to the original game. That is, a multiplayer library (as discussed below) may provide a multiplayer mode for a game developed with only a single player mode. Such may be useful in web-browsing environments or mobile devices, as these devices typically lack sophisticated processing power (as compared to console environments). Further, such embodiments may also streamline and provide comparatively efficient development of games operating in multiplayer mode, as may be achieved, in some cases, by leveraging the single player mode game to play in multiplayer mode.

### Example System

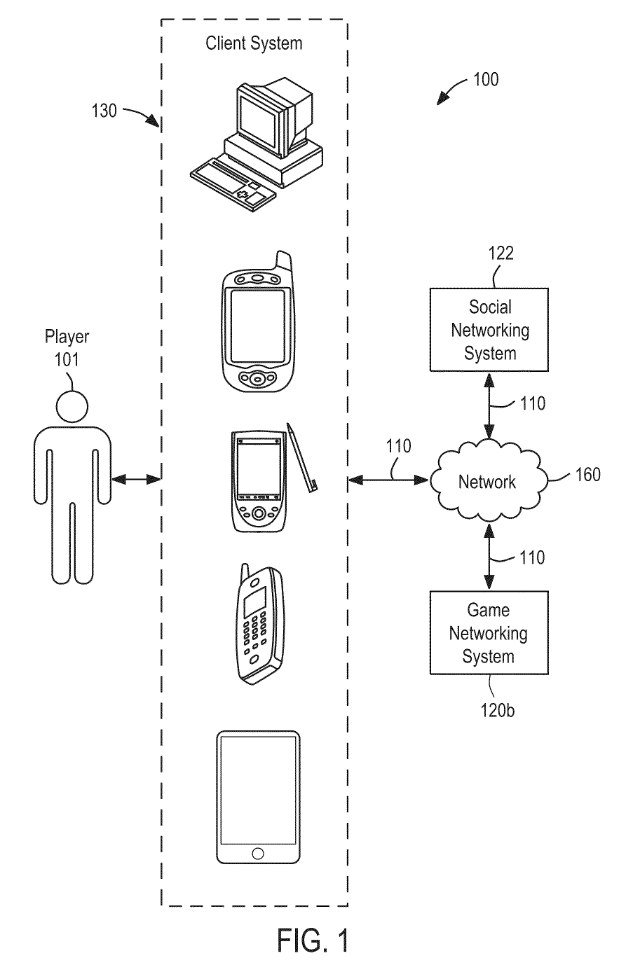

FIG. 1 illustrates an example of a system for implementing various disclosed embodiments. In particular embodiments, system 100 comprises player 101, social networking system 122, game networking system 120, client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 122 is a network-addressable computing system that can host one or more social graphs. Social networking system 122 can generate, store, receive, and transmit social networking data. Social networking system 122 can be accessed by the other components of system 100 either directly or via network 160. Game networking system 120 is a network-addressable computing system that can host one or more online games. Game networking system 120 can generate, store, receive, and transmit game-related data, such as, for example, game account data, game input, game state data, and game displays. Game networking system 120 can be accessed by the other components of system 100 either directly or via network 160. Player 101 may use client system 130 to access, send data to, and receive data from social networking system 122 and game networking system 120. Client system 130 can access social networking system 122 or game networking system 120 directly, via network 160, or via a third-party system. As an example and not by way of limitation, client system 130 may access game networking system 120 via social networking system 122. Client system 130 can be any suitable computing device, such as a personal computer, laptop, cellular phone, smart phone, computing tablet, and the like.

Although FIG. 1 illustrates a particular number of players 101, social networking systems 122, game networking systems 120, client systems 130, and networks 160, this disclosure contemplates any suitable number of players 101, social networking systems 122, game networking systems 120, client systems 130, and networks 160. As an example and not by way of limitation, system 100 may include one or more game networking systems 120 and no social networking systems 122. As another example and not by way of limitation, system 100 may include a system that comprises both social networking system 122 and game networking system 120. Moreover, although FIG. 1 illustrates a particular arrangement of player 101, social networking system 122, game networking system 120, client system 130, and network 160, this disclosure contemplates any suitable arrangement of player 101, social networking system 122, game networking system 120, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between player 101, social networking system 122, game networking system 120, client system 130, and network 160, this disclosure contemplates any suitable connections between player 101, social networking system 122, game networking system 120, client system 130, and network 160. As an example and not by way of limitation, in particular embodiments, client system 130 may have a direct connection to social networking system 122 or game networking system 120, bypassing network 160.

### Online Games and Game Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game can be hosted by game networking system 120, which can be accessed using any suitable connection with a suitable client system 130. A player 101 may have a game account on game networking system 120, wherein the game account can contain a variety of information associated with the player 101 (e.g., the player's personal information, financial information, purchase history, player character state, game state). In some embodiments, the player 101 may play multiple games on game networking system 120, which may maintain a single game account for the player 101 with respect to all the games, or multiple individual game accounts for each game with respect to the player 101. In some embodiments, game networking system 120 can assign a unique identifier to each player 101 of an online game hosted on game networking system 120. Game networking system 120 can determine that a player 101 is accessing the online game by reading the user's cookies, which may be appended to HTTP requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmit user inputs or other events to the game engine, and receive instructions from the game engine. The game engine can be executed on any suitable system (such as, for example, client system 130, social networking system 122, or game networking system 120). As an example and not by way of limitation, client system 130 can download client components of an online game, which are executed locally, while a remote game server, such as game networking system 120, provides backend support for the client components and may be responsible for maintaining application data of the game, processing the inputs from the player 101, updating and/or synchronizing the game state based on the game logic and each input from the player 101, and transmitting instructions to client system 130. As another example and not by way of limitation, each time player 101 provides an input to the game through the client system 130 (such as, for example, by typing on the keyboard or clicking the mouse of client system 130), the client components of the game may transmit the player's input to game networking system 120.

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and so forth. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player 101.

In particular embodiments, player 101 may access particular game instances of an online game. A game instance is a copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players 101. A game instance is associated with a specific player 101 when one or more game parameters of the game instance are associated with the specific player 101. As an example and not by way of limitation, a game instance associated with a first player 101 may be named “First Player's Play Area.” This game instance may be populated with the first player's PC and one or more in-game objects associated with the first player 101. In particular embodiments, a game instance associated with a specific player 101 may only be accessible by that specific player 101. As an example and not by way of limitation, a first player 101 may access a first game instance when playing an online game, and this first game instance may be inaccessible to all other players 101. In other embodiments, a game instance associated with a specific player 101 may be accessible by one or more other players, either synchronously or asynchronously with the specific player's game play. As an example and not by way of limitation, a first player 101 may be associated with a first game instance, but the first game instance may be accessed by all first-degree friends in the first player's social network. In particular embodiments, the game engine may create a specific game instance for a specific player 101 when that player 101 accesses the game. As an example and not by way of limitation, the game engine may create a first game instance when a first player 101 initially accesses an online game, and that same game instance may be loaded each time the first player 101 accesses the game. As another example and not by way of limitation, the game engine may create a new game instance each time a first player 101 accesses an online game, wherein each game instance may be created randomly or selected from a set of predetermined game instances. In particular embodiments, the set of in-game actions available to a specific player 101 may be different in a game instance that is associated with that player 101 compared to a game instance that is not associated with that player 101. The set of in-game actions available to a specific player in a game instance associated with that player 101 may be a subset, superset, or independent of the set of in-game actions available to that player 101 in a game instance that is not associated with him. As an example and not by way of limitation, a first player 101 may be associated with Blackacre Farm in an online farming game. The first player 101 may be able to plant crops on Blackacre Farm. If the first player 101 accesses a game instance associated with another player 101, such as Whiteacre Farm, the game engine may not allow the first player 101 to plant crops in that game instance. However, other in-game actions may be available to the first player 101, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, and the like). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure includes any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 122 or game networking system 120). In one embodiment, Nₘₐₓ equals 1, such that the player's social network includes only first-degree friends. In another embodiment, Nₘₐₓ is unlimited and the player's social network is coextensive with the social graph.

In particular embodiments, the social graph is managed by game networking system 120, which is managed by the game operator. In other embodiments, the social graph is part of a social networking system 122 managed by a third-party (e.g., Facebook®, Friendster, Myspace). In yet other embodiments, player 101 has a social network on both game networking system 120 and social networking system 122, wherein player 101 can have a social network on the game networking system 120 that is a subset, superset, or independent of the player's social network on social networking system 122. In such combined systems, game network system 120 can maintain social graph information with edge type attributes that indicate whether a given friend is an “in-game friend,” an “out-of-game friend,” or both. The various embodiments disclosed herein are operable when the social graph is managed by social networking system 122, game networking system 120, or both.

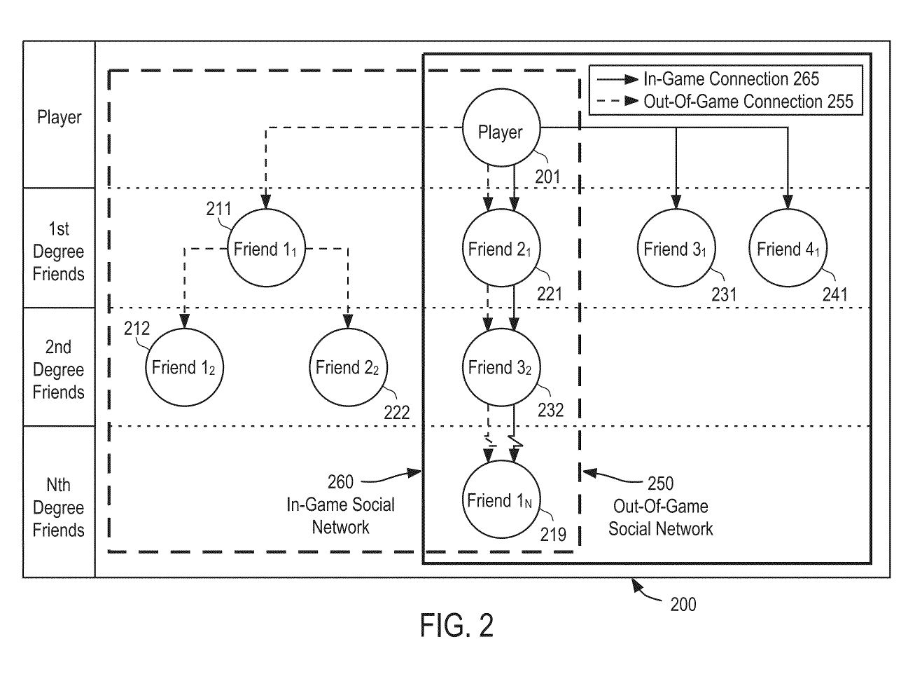

FIG. 2 shows an example of a social network within a social graph, according to an example embodiment. As shown, Player 201 can be associated, connected or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of social network 250 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 122.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access in-game social network 260, out-of-game social network 250, or both.

In particular embodiments, the connections in a player's in-game social network can be formed both explicitly (e.g., users must “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

### Example Modules of a Multiplayer Synchronous Gaming System

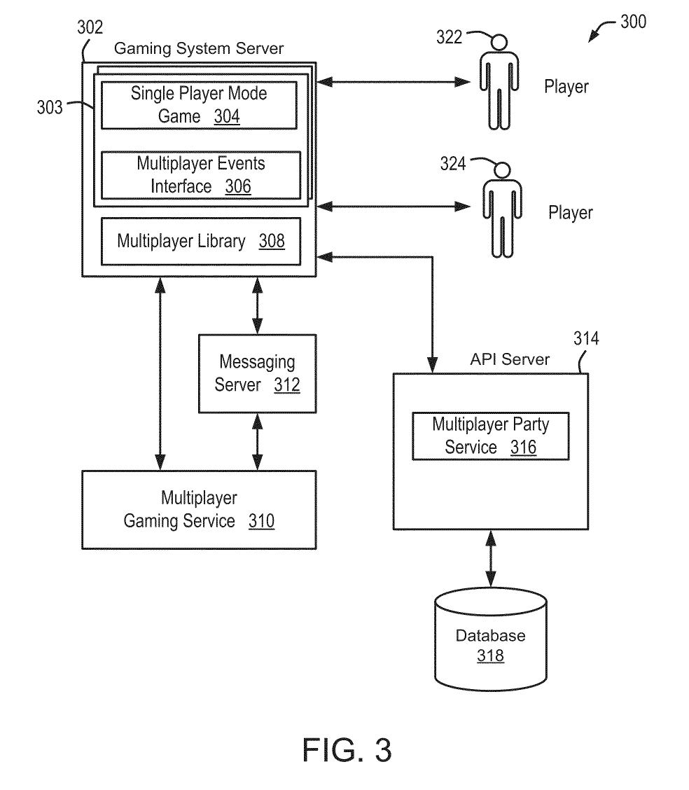

FIG. 3 illustrates an example of a multiplayer gaming system 300 for implementing multiplayer games, according to an example embodiment. As described herein, the multiplayer gaming system 300 allows multiple users to compete in a game at substantially the same time. The multiplayer gaming system 300 includes a gaming system server 302, a multiplayer gaming service 310, a messaging server 312, and an API server 314. The gaming system server 302 includes one or more instances of a multiplayer instance 303 and a multiplayer library 308. Each multiplayer instance 303 may include an instance of a single player mode game 304 and a multiplayer events interface 306. In some embodiments, each of the multiplayer instances 303 may be created for one of the players 320, 322. It is to be appreciated that an individual multiplayer instance 303, as used herein, may refer to an instance of a game that is enabled to be played with other instances of the same multiplayer games. Thus, when multiple multiplayer games are joined or otherwise connected by the systems and components described herein, the simultaneous playing of each of the individual multiplayer games may constitute as a multiplayer game (e.g., that is, each multiplayer instance is started substantially at the same time as the other multiplayer instances, and the final score may be compared to the scores with each other to determine a winner, etc.). Depending on the embodiment utilized, the multiplayer instance 303 may execute on the game system server 302, the client device corresponding the player (player 322 or 324), or some combination thereof.

The single player mode game 304 may be an instance of a single player mode game. That is, the single player mode game 304 may include data or logic, such as a game engine, for playing a round or turn for a single player. Other than interfacing with the multiplayer events interface 306, the single player mode game 304 may lack multiplayer functionality.

The multiplayer events interface 306 may be an interface that allows the single player mode game 304 to operate in a multiplayer mode by interfacing the single player mode game 304 with other single player mode games from other multiplayer game instances through the multiplayer library 308. In some embodiments, the multiplayer events interface 306 communicates with the multiplayer library 308 through an event mechanism to identify various events associated with the multiplayer gaming operations. The multiplayer library 308 may be, in an example embodiment, a JavaScript library that supports the communication of data between the single player mode game 304 and the multiplayer gaming systems and methods. The multiplayer library 308 tracks various data related to one or more multiplayer games, such as the players who have been matched and are currently in a game, player scores, and players who want to play in another game (e.g., a rematch).

The multiplayer gaming service 310 interacts with the gaming system server 302 and supports the multiplayer gaming system and some of the methods discussed herein. In some embodiments, the multiplayer gaming service 310 receives requests from individual multiplayer games to find other players for a multiplayer game. In these embodiments, the multiplayer gaming service 310 receives these requests to find players and matches multiple players together for a particular multiplayer game. The multiplayer gaming service 310 may also detect the online presence of other players (e.g., potential players in a multiplayer game) and may notify other players regarding your online presence.

The messaging server 312 communicates messages and other data between the multiple players participating in a specific game. In some embodiments, the messaging server 312 sends and receives messages between multiple players in substantially real time. The API server 314 and a multiplayer party service 316 handle party (or group) persistence across different games or different game matches. For example, a group of players may play multiple games against each other in multiple game sessions. These multiple game sessions may extend across multiple days, weeks, months or years. The API server 314 and the multiplayer party service 316 track the data associated with these multiple games and store the data in a database 318. The tracked data includes, for example, games played, game scores, individual game winners, overall game leaders, and the like. In some embodiments, the API server 314 handles API calls from one or more client systems.

In some embodiment, the multiplayer gaming system 300 is deployed as part of the game networking system 120 of FIG. 1.

### Example API of a Multiplayer Synchronous Gaming System

As described above, example embodiments may utilize an event messaging system to provide synchronous multiplayer support for games existing single player mode games. Table 1 below identifies example events communicated between the various games/client systems during a multiplayer game.

TABLE 1

| | | How/when to interact | |
|---|---|---|---|
| Event Name | Description | with the event | Parameters |
| multiplayerEnabled | Indicates that the | Raise when the game | |
| | game is ready for | is loaded and ready for | |
| | multiplayer play | multiplayer play | |
| multiplayerDisabled | Indicates that the | Raise when the game | |
| | game is not | is in a single player | |
| | available for | level or single player | |
| | multiplayer play | mode | |
| matchmakingEnded | All opponents | After receiving this | players: list of objects |
| | have been found | event, start loading the | for all the players |
| | for the multiplayer | multiplayer level, then | that will participate |
| | match. Players and | send “gameReady” | in the competition |
| | game may not yet | when done loading | |
| | be ready to start | | |
| | the match | | |
| gameReady | Multiplayer level/ | Raise when | |
| | setup is done for | multiplayer level is | |
| | the logged in user | finished loading, then | |
| | and game is ready | wait for the | |
| | to start when | “startGame” event | |
| | signaled | | |
| startGame | Start the | After receiving this | |
| | multiplayer game. | event, start the | |
| | Will be raised only | multiplayer game. If | |
| | when all players' | appropriate, start the | |
| | games are ready | countdown | |
| gameStarted | The game has | Raise when the game | |
| | started | has started. Usually | |
| | | this is immediately | |
| | | after receiving the | |
| | | startGame event, but | |
| | | may be raised later | |
| score | You have scored | Raise when the logged | score: updated score |
| | | in user has scored | |
| score (other player) | Another player has | After receiving this | id: other player who |
| | scored | event, update score | has scored |
| | | display for other | score: updated score |
| | | player(s) | |
| gameEnded | Your game has | Raise when the logged | score: final score |
| | ended | in user is either done | |
| | | with the multiplayer | |
| | | level or the game timer | |
| | | has expired | |
| gameSeed | If you have | After receiving this | seed: string blob |
| | implemented the | event, load the game | containing seed data |
| | getGameSeed | level based on the seed | |
| | method, then all | given | |
| | players receive a | | |
| | gameSeed event | | |
| | once they join the | | |
| | matchmaking | | |
| | process. This | | |
| | event will provide | | |
| | the consensus seed | | |
| | that all players | | |
| | have agreed on so | | |
| | that you can load | | |
| | the multiplayer | | |
| | levels with a | | |
| | common seed | | |
| gameEvent | Generic game | Custom | Custom |
| | information (once | | |
| | a game is in | | |
| | progress) | | |

In addition to the event messages described above in Table 1, example embodiments may include provide an API that is implemented by the existing game so that the existing game can interface with the multiplayer library 308, the multiplayer gaming service 310, and/or the API server 314. Table 2 below identifies example methods that may be implemented by the single player mode game 304 during a multiplayer game.

TABLE 2

| Method | | | |
|---|---|---|---|
| Name | Information | Parameters | Return Value |
| getGameSeed | Implement this method | None | Return whatever |
| | to sync each player | | representation of a |
| | with a common level | | seed you need to |
| | or setting. Return a seed | | initialize a |
| | to be passed along to all | | multiplayer level |
| | the other players. | | |
| | Each player will | | |
| | receive a gameSeed | | |
| | event with the first | | |
| | seed that is sent to | | |
| | the server. | | |
| checkEnergy | Implement this method | None | Return true if the |
| | to add an energy level | | user has enough |
| | gate associated with | | energy for a |
| | a player or a player | | multiplayer game; |
| | character that needs to | | false otherwise |
| | be checked before | | |
| | starting a new | | |
| | multiplayer game | | |
| buyEnergy | If you implemented | None | Return true if the |
| | the checkEnergy | | user had bought |
| | method and | | energy for a |
| | there's not enough | | multiplayer game; |
| | energy, the platform | | false otherwise |
| | will also call this | | |
| | method so the system | | |
| | can present an | | |
| | in-game “get more | | |
| | energy” dialog | | |
| getRewards | Implement this | None | Return an array of |
| | method to | | four reward objects |
| | provide rewards | | in order of first to |
| | to the game | | last place, |
| | winners | | containing two |
| | | | properties: |
| | | | image: URL of the |
| | | | reward image |
| | | | amount: amount of |
| | | | the currency |
| | | | rewarded |

### Example Methods of a Multiplayer Synchronous Gaming System

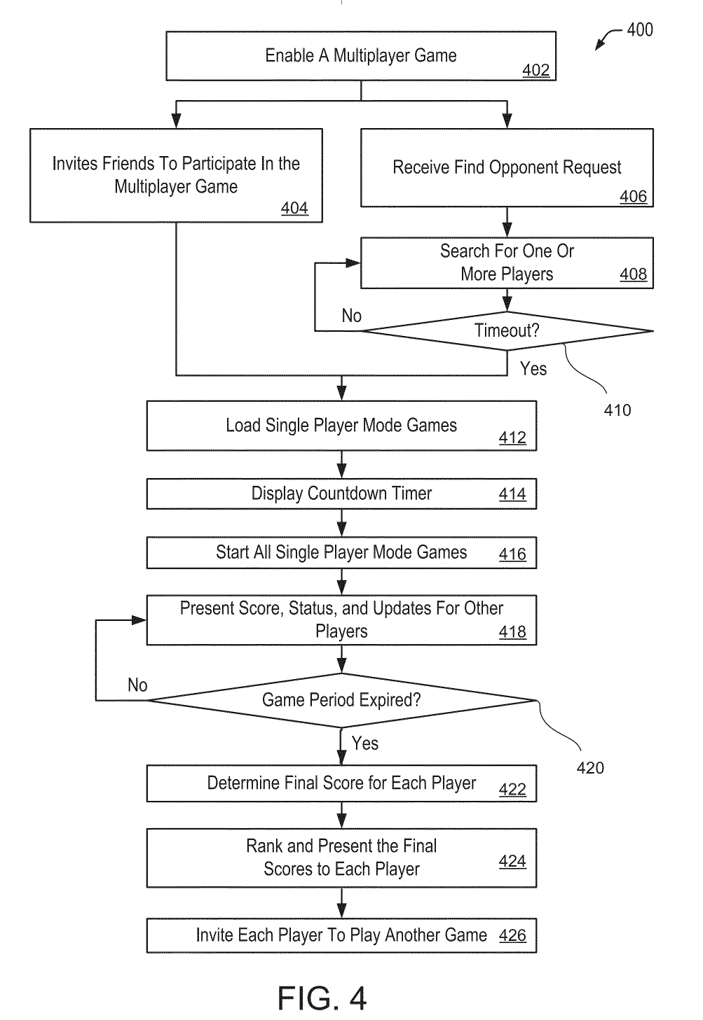

FIG. 4 is a flow diagram illustrating an example method 400 for implementing a multiplayer game, according to an example embodiment. In particular embodiments, the method 400 is implemented by one or more processors, as may be executed by one or more modules shown in FIG. 3.

The method 400 begins, at operation 402, when the multiplayer instance 303 of FIG. 3 enables a multiplayer game for of a game hosted by the gaming system server 302. In some embodiments, the operation 402 may be performed responsive to detecting a request initiated by a first player. For example, the first player may activate a “Play Live”, “Game Challenge” or similar button presented through a user interface (e.g., a menu) for the game. With respect to Table 1, the multiplayer instance 303 may perform operation 402 in conjunction with sending a ‘multiplayerEnabled’ event to the multiplayer library 308. In turn, according to some embodiments, the multiplayer library 308 may communicate with the multiplayer gaming service 310 to indicate that the player is available for playing in a multiplayer game.

As described above, the multiplayer gaming system 300 may offer services, as may be initiated by the first player, for sending invitations to friends to participate in the multiplayer game or to request the gaming system to find other players for the multiplayer game. If the first player wants to invite friends, operation 404 is performed by the process 400, which may involve the multiplayer library 308 sending game invitation messages to user selected friends. The user selected friends, in example embodiments, may be user selections obtained by the multiplayer instance 303 as a result of the multiplayer instance 303 accessing a contact list of the first player and presenting a list of one or more of those friends who are currently online and/or currently playing other games to the first player. In a particular embodiment, a multiplayer game is limited to a determinable number of players (e.g., up to four players).

If the first player wishes the gaming system server 302 to select players for the multiplayer game, the multiplayer library 308 may receive a find friends request at operation 406. Responsive to receiving the find friend request, the multiplayer library 308, at operation 408, searches, possibly using the multiplayer gaming service 310, for one or more players who are currently online and have expressed an interest in joining a multiplayer game. The multiplayer library 308 may send requests to multiple players asking if they want to participate in the multiplayer game.

At decision 410, the multiplayer library 308 may determine whether a search timeout condition has been triggered. A variety of events may trigger a search timeout condition. For example, according to some embodiments, the method 400 searches for players for a determinable amount of time (referred to as a search timeout threshold). By way of example and not limitation, 40 seconds may be an example of a search timeout threshold but one skilled in the art would appreciated that any determinable amount of time may be used. If the game system has been searching for players for the multiplayers instance greater than the search timeout threshold, the game system may trigger a search timeout condition. As another example, according to some example embodiments, the method 400 may search until a maximum number of players have been selected to join the multiplayer instance of the game. If the maximum number of players is reached, the game system may trigger a search timeout condition.

In an example embodiment, operations 404, 406, 408, and 410 may be performed by one or more of the multiplayer library 308, the multiplayer gaming service 310, and/or the API server 314. Further, in some embodiments, after operations 404, 406, 408, and 410 complete, the multiplayer gaming service 310 may communicate the ‘matchmakingEnded’ event (see, e.g., Table 1 above) to the players that are participating in the multiplayer game.

After selecting one or more players to play the multiplayer instance 303, the method 400 loads the single player mode game 304 on each of the player's client devices. This is shown as operation 412. Operation 412 may involve displaying an initial game screen to all players participating in the multiplayer game. In some cases, operation 412 may performed responsive to receiving the ‘matchmakingEnded’ event (see, e.g., Table 1 above). Additionally, at operation 414, some embodiments of the method 400 may display a countdown timer to all players. The countdown timer indicates, for example, the number of seconds until the multiplayer game begins.

At the appropriate time (e.g., the multiplayer game start time), the game library 308, at operation 416, may start each single player mode game 304 for each of the multiplayer instances 303 at substantially the same time. Starting the single player mode games may involve the multiplayer library 308 sending data that instructs each single player mode game 304 to start at substantially the same time. Due to differences in data communication speeds, latencies, player computing devices, and the like, the actual start time for each game may vary slightly (e.g., by a few seconds). In one embodiment, when a client device is done loading the single player mode game 304 for the multiplayer instance 303, the client device may communicate a ‘gameReady’ event to the multiplayer library 308 or the multiplayer gaming service 310. Once the multiplayer library 308 receives ‘gameReady’ events from each of the players, a ‘gameStart’ event is communicated to each of the single player mode games. Once the single player mode game is started on the client devices, the client devices may then communicate a ‘gameStarted’ event back to the multiplayer library 308 of the gaming system server 302.

At operation 418, the multiplayer gaming system 300 causes information regarding other players in the multiplayer game to be displayed by each player's game display (e.g., game interface). This information includes, for example, name, picture, score, status, and updates associated with the other players participating in the multiplayer game. Such information may be communicated when the multiplayer library 308 receives ‘score’ or ‘gameEvent’ events from one or more multiplayer instances and communicates corresponding the ‘score (other player)’ events and ‘gameEvent’ events to the other multiplayer instances.

As mentioned above, games between instances of the multiplayer instances may involve a predetermined time period of gameplay, such as 60 seconds. The method 400 continues displaying information regarding other players on each player's game while the multiplayer game is being played, as may be determined by decision 420. It is to be appreciated that although operation 422 is described with reference to a time period, and game condition may be used to determine when the game is to end. For example, the multiplayer game may end when a particular score is achieved by one player or when a challenge has been completed. Once the game has ended, each multiplayer instance 303 may communicate a ‘gameEnded’ to the other multiplayer game instances 310. In some cases, when the multiplayer library 308 receives a ‘gameEnded’ event from all the multiplayer instances, the multiplayer gaming server 310 may communicate a ‘matchEnded’ to each of the multiplayer instances.

When the predetermined time period for the multiplayer game ends, at operation 422, each multiplayer instance determines a final score for each player. In some embodiments, the final score for each player is calculated by the multiplayer instance 303 and communicated to multiplayer library 308 or other component in the multiplayer gaming system 300. In other embodiments, a server of the game system calculates the final score for each player and that score is pushed down to the individual computing devices.

The multiplayer game instances 303 may then rank, at operation 424, the final scores and present the ranked final scores to each player. Additionally, the multiplayer game library may invite, at operation 426, each player to play another game with the same group of players or with a different group of players.

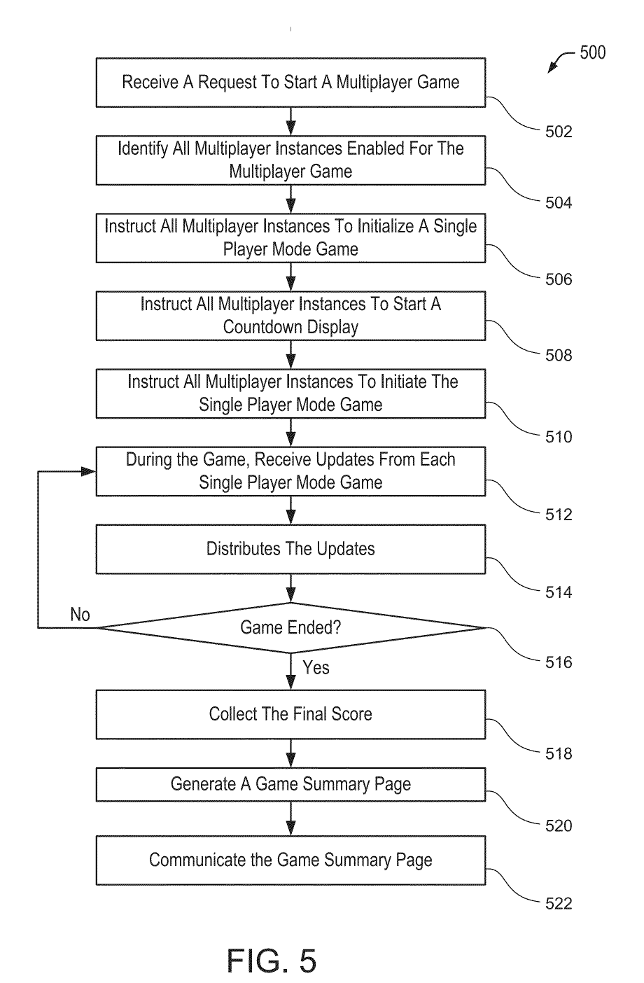

FIG. 5 is a flow diagram illustrating an example method 500 for managing multiple multiplayer instances involved in a multiplayer game. In particular embodiments, the method 500 is implemented using one or more processors in the components or modules shown in the multiplayer gaming system 300 of FIG. 3.

Initially, at operation 502, the multiplayer library 308 receives a request to start a multiplayer game. The multiplayer library 308 then identifies, at operation 504, all multiplayer instances that are enabled for the multiplayer game. For example, the multiplayer instance may correspond to a client device operating an instance of the game. As discussed above, the client device may be coupled to the multiplayer library 308 via one or more networks or other data communication mechanisms.

At operation 506, the method 500 continues as the multiplayer library 308 instructs all multiplayer instances to initialize a single player mode game (e.g., game board) with specific settings and parameters. This initialization ensures that all players are playing the same single player mode game under the same conditions. For example, each player may start the single player mode game with the same skills, abilities, virtual currency, in-game assets, and the like. Additionally, the settings and parameters may define various rules or limitations associated with the single player mode game. The settings and parameters also include the time period for the single player mode game and information (e.g., game score and game activities) that the single player mode game should communicate to the multiplayer library 308 during the game play. As discussed above relative to Table 1, the gameSeed event may be used to communicate a seed that is usable to select a level or property common to all multiplayer instances.

At operation 508, the method 500 continues as the multiplayer library 308 instructs all multiplayer instances to start a countdown display (e.g., several seconds before the start of the single player mode game). Each multiplayer instance displays the countdown display (e.g., countdown timer) to the player using the client system. This countdown display notifies the game participants that the game is about to begin and allows the participants to prepare for the game. At the start time of the game, the multiplayer library instructs, at operation 510, all multiplayer instances to initiate the game using the specific settings and parameters previously provided.

During the game, the multiplayer game library 308, at operation 512, receives updates from each of the multiplayer instances, and, at operation 514, distributes those updates to all other multiplayer instances. Thus, according to an example embodiment, each client system receives score updates and other information associated with the other players in the game from the multiplayer library 308.

At decision 516, the multiplayer library 308 determines whether to end the game, as may be determined based on determining that a predetermined time period for the game has expired. If yes, the multiplayer library 308 collects, at operation 518, the final scores and other information from each multiplayer instance. If not, the multiplayer library 308 continues to operation 512.

At operation 520, the multiplayer library 308 generates a summary page that includes the final scores, identification of the winning player, and other game-related information based at least in part on the information received from the client systems. The summary page is then communicated to each of the multiplayer instance for display to the player corresponding to that multiplayer instance at operation 522. As discussed herein, the summary page may also include an invitation to play another game and/or add any of the other players to a “game friends” list.

### Example Methods of a Multiplayer Synchronous Gaming System

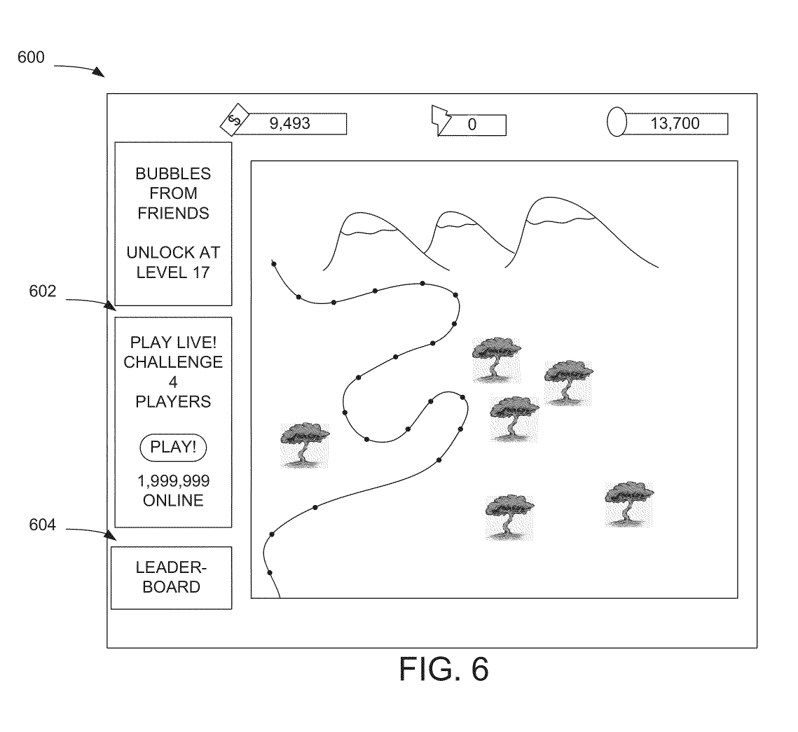

FIG. 6 illustrates an example user interface 600 enabling a display of, and interaction with, various aspects of a multiplayer game provided multiplayer instances of a single player mode game. User interface 600 includes a multiplayer button 602 (also referred to as a “play live button”) to initiate a multiplayer version of the displayed game, and a leader board button 604 that displays the status of one or more players in one or more multiplayer games. For example, activating the leader board button 604 may display a leader board ranking the player viewing the user interface 600 along with other players who participated in games with the viewing player.

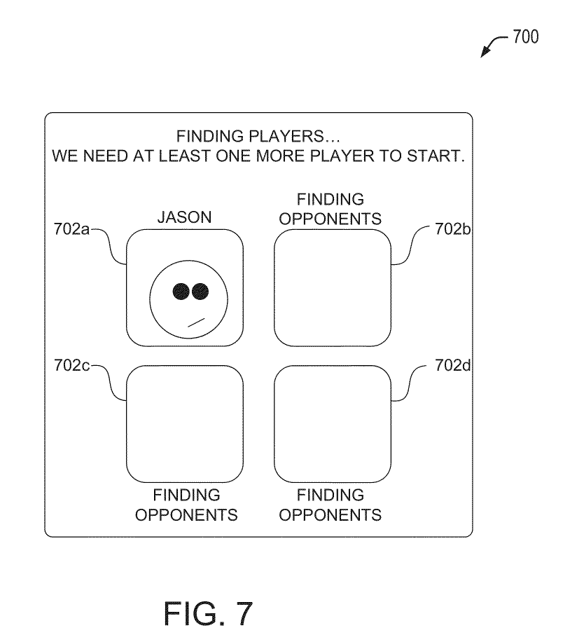

FIG. 7 illustrates an example user interface 700 that indicates that the multiplayer library 308 is searching for other players to join a multiplayer game with the player viewing user interface 700. In this example, the user interface 700 is associated with the game being played by the client device operated by a player named “Jason,” who initiated the request to play a multiplayer game. The user interface 700 may include status panels 702a-d to indicate the players that have joined the instance of the multiplayer game. The example illustrated in FIG. 7 shows that the status panel 702a indicates that Jason has joined the game and the status panels 702b-d indicate that the game system is still searching for additional players to join.

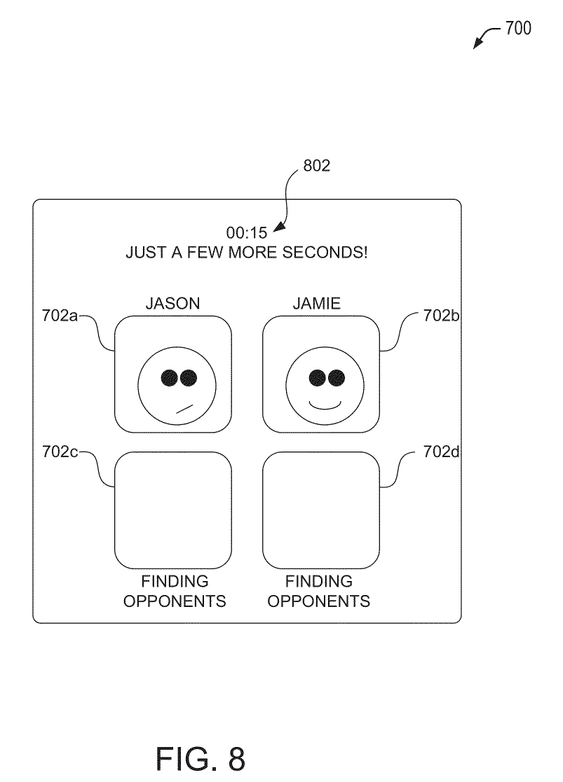

FIG. 8 illustrates another instance of the user interface 700 that displays the status of creating the multiplayer game at a later time, relative to FIG. 7. In the example shown in FIG. 8, the user interface now displays a timer 802 indicating that the multiplayer gaming system will search for another 15 seconds to locate additional players for the multiplayer game. In some embodiments, the timer 802 may be displayed when there is only a limited amount of time left or, in other embodiments, when the user interface 700 is initially displayed to the player. The status panel 702b now indicates that one additional player (“Jamie”) has been identified by the multiplayer gaming system as joining the instance of the multiplayer game, while the status panels 702c-d still indicate that the game system is searching for additional players to join. In some cases, the user interface 700 is now displayed on the client devices operated by Jason and Jamie.

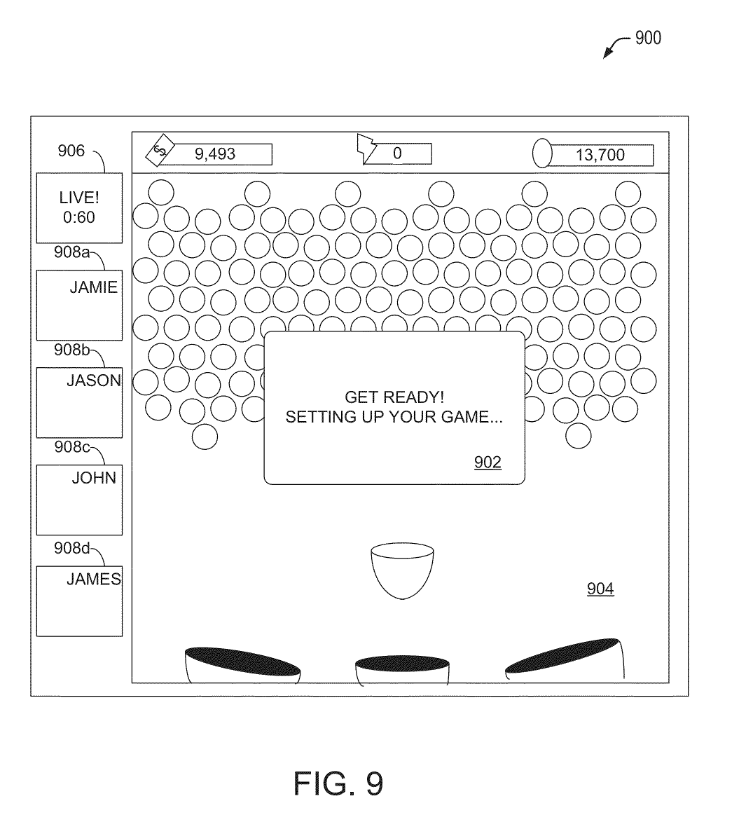

FIG. 9 illustrates an example user interface 900 that displays a “get ready” window 902 indicating that the single player mode game is being initialized on the client device and will start soon. The user interface 900 may further include a game play area module 904 that provides a visual indication of the single player mode game used in the multiplayer game, and a game timer 906, and player status modules 908a-d. As discussed above, embodiments may simulate multiplayer games by connecting multiple single player mode games. The game timer 906 may provide a timer that indicates the time remaining in the multiplayer game. The player status modules 908a-d may each identify a player in the multiplayer game. The example of FIG. 9 shows that the multiplayer game involves Jamie, Jason, John, and James. In addition to identifying the player, each player status module 908a-d may display the player's an avatar or other image associated with the player, the player's current score, and an indicator of recent activity or events in that player's game.

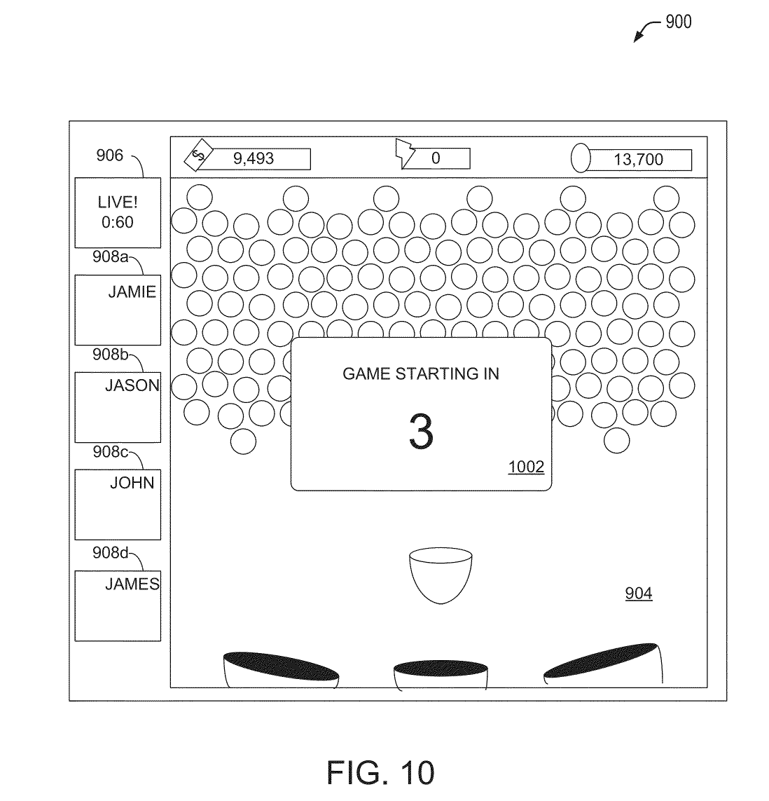

FIG. 10 illustrates the example user interface 900 now displaying another version of a “get ready” window 1002 in which a countdown timer is presented to the player of the multiplayer game. In this example, the game will start in approximately three seconds. The get ready window 1002 may be displayed on each client device being operated by the players of the multiplayer game.

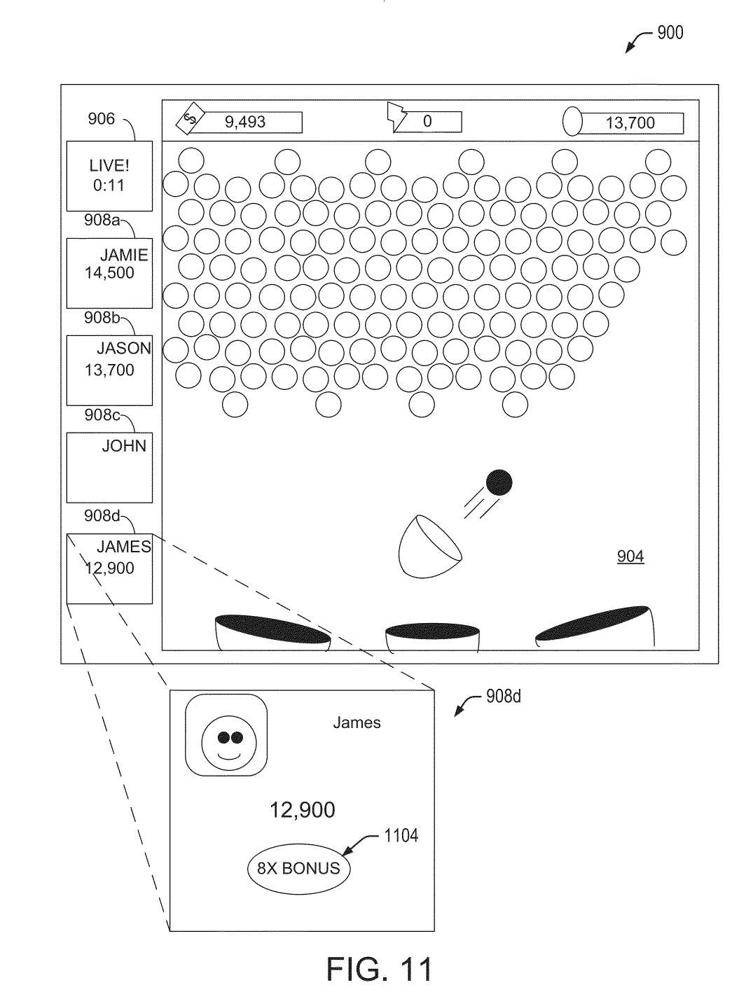

FIG. 11 illustrates the example user interface 900 updated to display an active single player mode game along with updates of the status of the players in the multiplayer game that are playing their respective single player mode games. Is shown in FIG. 11, the player status modules 908a-d have been updated to display the status (e.g., score) for each of the players in the multiplayer game. FIG. 11 shows an enlarged illustration of the player status module 908d corresponding to James. As shown in the enlargement of the player status module 908d, the status module 908d includes a recent event indicator 1104. The recent event indicator 1104 specifies that James just earned an “8× Bonus” in his instance of the multiplayer game. The ordering of the four players along the left edge of the user interface 1100 may be ordered based on the current player scores (highest score on top, next highest below the top scoring player, and so forth).

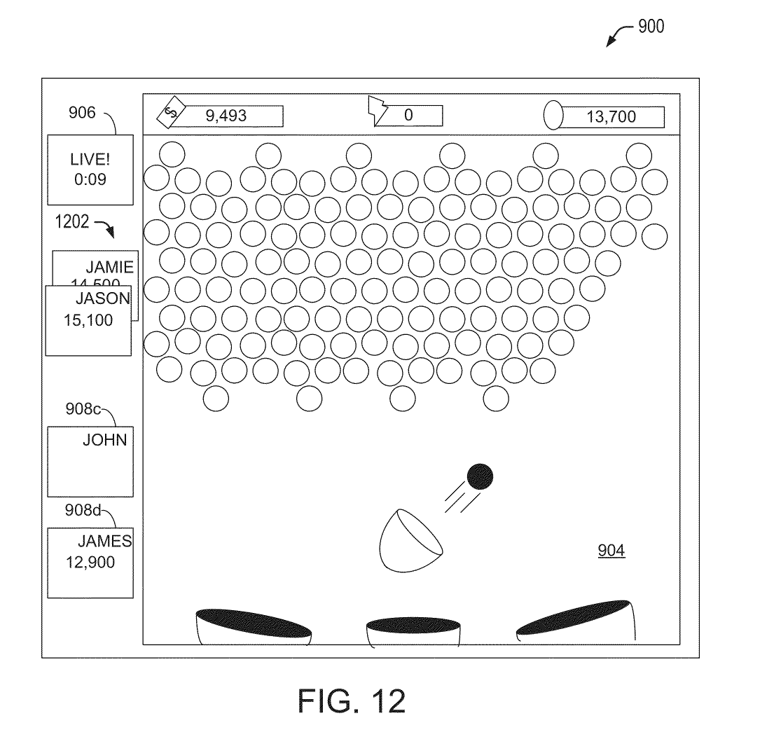

FIG. 12 illustrates the example user interface 900 being updated to reorder one or more player status modules, according to an example embodiment. This reordering, shown as movement 1202, may occur as a result of Jason's score surpassing Jamie's score, thereby making Jason the current highest scoring player. The position of the players changes during the game whenever the ordering or ranking of the players changes due to changes in game score and/or other factors. In some embodiments, an animated character, such as a bird, enters the user interface 900 and “assists” with the movement of players' positions along the left edge of the user interface 900.

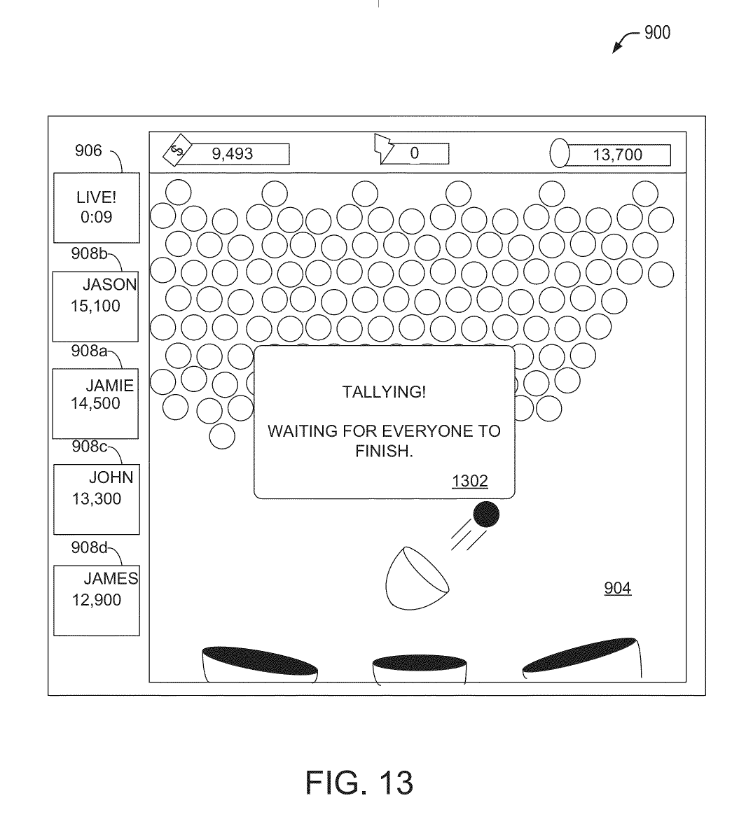

FIG. 13 illustrates the example user interface 900 updated to display a “tallying” window 1302 indicating that the game system is determining the final score of the multiplayer game. In some embodiments, the user interface 900 may be updated to include the tallying window 1302 responsive to the game timer 906 expiring.

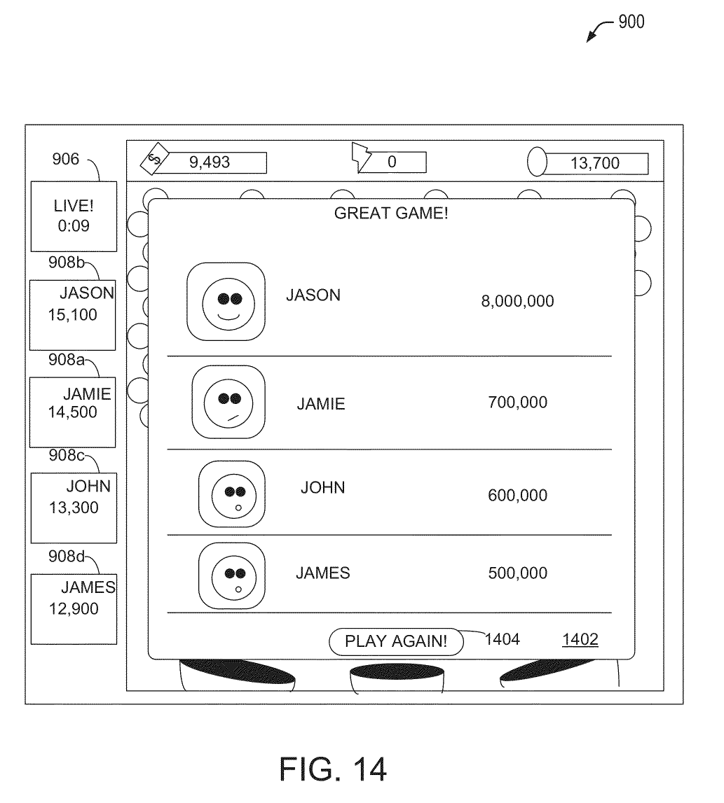

FIG. 14 illustrates the example user interface 900 updated to display a final ranking module 1402 that displays final ranking of the player participating in the multiplayer game. Further, the final ranking module 1402 may also include scores of all four players in the multiplayer game. Additionally, user interface 900 provides a “play again” button 1404 that allows the player to play another game with the same group of players or with a different group of players.

In some embodiments, the described systems and methods provide a flexible and simple framework that supports various types of multiplayer games by connecting and synchronizing the results of multiple single player mode games. This framework includes a communication model that allows any type of state information (e.g., player score, game activities, and game status information) to be passed between a server and multiple instances of the single player mode game being played on multiple client systems. This framework may leverage one or more messaging infrastructures.

In particular implementations, the systems and methods support persistent groupings of players across multiple game competitions or game matches (and across different game titles). For example, the same group of players may compete against each other in a variety of different game titles. The described systems and methods allow players to connect with one another through the various game competitions. Summary information is maintained for the players in the group across the multiple games and multiple competitions.

Some embodiments monitor player scores and changes to player scores over a period of time to identify potential cheaters. Scoring irregularities may indicate that a player is cheating or otherwise manipulating the game to achieve an improved score. For example, if a player's score typically increases by 1000-2000 points during a five second period, an increase of 100,000 points during a particular five second period may indicate cheating by the player.

In some implementations, a user may receive a request to participate in a synchronous multiplayer game while the user is already playing another asynchronous game. In this situation, the user is given the opportunity to suspend activity in the asynchronous game while playing the synchronous multiplayer game. After completing the synchronous multiplayer game, the user can return to finish the asynchronous game. Since the asynchronous game is not played during a specified time period, the user can return to the asynchronous game without loss of points or status in the asynchronous game.

In particular embodiments, the described systems and methods support various activities that occur outside of the game application itself. For example, the finding of other players (e.g., matchmaking) may be presented on the same display screen as the multiplayer game, but actually implemented by a different application. Additionally, friend requests and other game friending operations may be implemented by an application other than the game application. This allows the game portion of the display to change without affecting the other activities controlled by other applications.

Some embodiments allow one player in a multiplayer game to positively or negatively impact other players in the multiplayer game. For example, one player may send a bonus or in-game asset to one or more other players of the game. Alternatively, one player may send a detriment or inflict a penalty on one or more other players of the game. In a particular implementation, when one player receives a bonus while playing the multiplayer game, other players of the game receive a similar bonus. For example, if one player receives a bonus of three bullets, other players in the game may each receive a bonus of one bullet.

Particular implementations of the systems and methods described herein award prizes for one or more top scoring players in a game. Example prizes include virtual coins, energy, bonus tools, and other advantages for use in future games (either multiplayer games or single player mode games). The prizes may be applicable to the same game in which they were earned or may be associated with a different game title.

### Example Data Flow

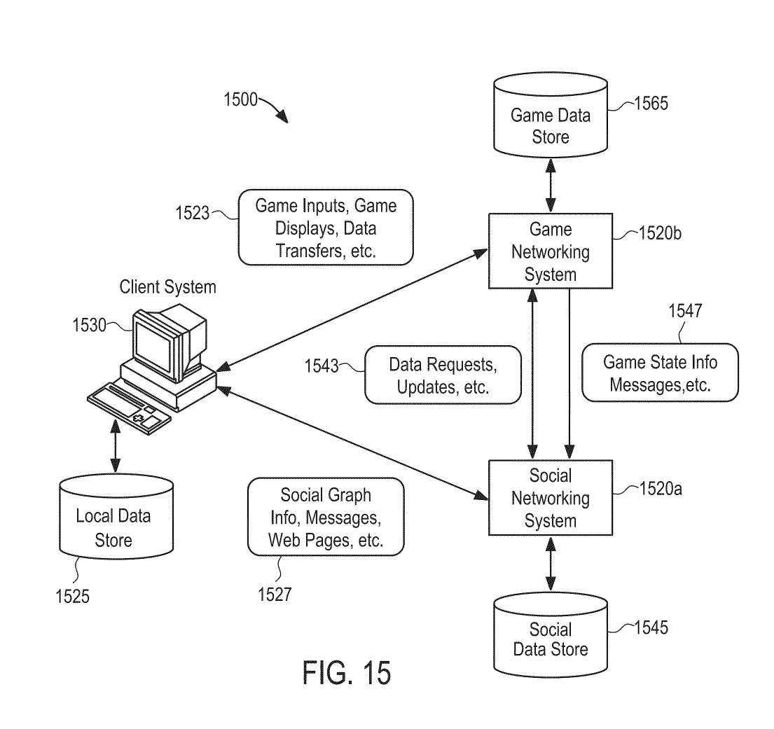

FIG. 15 illustrates an example data flow between the components of system 1500. In particular embodiments, system 1500 can include client system 1530, social networking system 1520a, and game networking system 1520b. The components of system 1500 can be connected to each other in any suitable configuration, using any suitable type of connection. The components may be connected directly or over any suitable network. Client system 1530, social networking system 1520a, and game networking system 1520b can each have one or more corresponding data stores such as local data store 1525, social data store 1545, and game data store 1565, respectively. Social networking system 1520a and game networking system 1520b can also have one or more servers that can communicate with client system 1530 over an appropriate network. Social networking system 1520a and game networking system 1520b can have, for example, one or more internet servers for communicating with client system 1530 via the Internet. Similarly, social networking system 1520a and game networking system 1520b can have one or more mobile servers for communicating with client system 1530 via a mobile network (e.g., GSM, PCS, Wi-Fi, WPAN, and the like). In some embodiments, one server may be able to communicate with client system 1530 over both the Internet and a mobile network. In other embodiments, separate servers can be used.

Client system 1530 can receive and transmit data 1523 to and from game networking system 1520b. This data can include, for example, webpages, messages, game inputs, game displays, HTTP packets, data requests, transaction information, updates, and other suitable data. At some other time, or at the same time, game networking system 1520b can communicate data 1543, 1547 (e.g., game state information, game system account information, page info, messages, data requests, updates, and so forth) with other networking systems, such as social networking system 1520a (e.g., Facebook®, Myspace, and the like). Client system 1530 can also receive and transmit data 1527 to and from social networking system 1520a. This data can include, for example, webpages, messages, social graph information, social network displays, HTTP packets, data requests, transaction information, updates, and other suitable data.

Communication between client system 1530, social networking system 1520a, and game networking system 1520b can occur over any appropriate electronic communication medium or network using any suitable communications protocols. For example, client system 1530, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 1520b, the BLOB containing the game state for the instance corresponding to the player can be transmitted to client system 1530 for use by a client-side executed object to process. In particular embodiments, the client-side executable may be a FLASH-based game, which can de-serialize the game state data in the BLOB. As a player plays the game, the game logic implemented at client system 1530 maintains and modifies the various game state parameters locally. The client-side game logic may also batch game events, such as mouse clicks, and transmit these events to game networking system 1520b. Game networking system 1520b may itself operate by retrieving a copy of the BLOB from a database or an intermediate memory cache (memcache) layer. Game networking system 1520b can also de-serialize the BLOB to resolve the game state parameters and execute its own game logic based on the events in the batch file of events transmitted by the client to synchronize the game state on the server side. Game networking system 1520b may then re-serialize the game state, now modified, into a BLOB and pass this to a memory cache layer for lazy updates to a persistent database.

With a client-server environment in which the online games may run, one server system, such as game networking system 1520b, may support multiple client systems 1530. At any given time, there may be multiple players at multiple client systems 1530, all playing the same online game. In practice, the number of players playing the same game at the same time may be very large. As the game progresses with each player, multiple players may provide different inputs to the online game at their respective client systems 1530, and multiple client systems 1530 may transmit multiple player inputs and/or game events to game networking system 1520b for further processing. In addition, multiple client systems 1530 may transmit other types of application data to game networking system 1520b.

In particular embodiments, a computer-implemented game may be a text-based or turn-based game implemented as a series of web pages that are generated after a player selects one or more actions to perform. The web pages may be displayed in a browser client executed on client system 1530. As an example and not by way of limitation, a client application downloaded to client system 1530 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF (Small Web Format) object that is embedded in a web page and executable by a Flash media player plug-in. In particular embodiments, one or more described webpages may be associated with or accessed by social networking system 1520a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1530, either caused by an action of a game player or by the game logic itself, client system 1530 may need to inform game networking system 1520b of the update. For example, if the game is a farming game with a harvest mechanic (such as Zynga® FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1500 is discussed in reference to updating a multi-player online game hosted on a network-addressable system (such as, for example, social networking system 1520a or game networking system 1520b), where an instance of the online game is executed remotely on a client system 1530, which then transmits application event data to the hosting system such that the remote game server synchronizes game state associated with the instance executed by the client system 1530.

In particular embodiments, one or more objects of a game may be represented as an Adobe® Flash (or other authoring environment, such as HTML5) object. Flash may manipulate vector and raster graphics, and supports bidirectional streaming of audio and video. “Flash” may mean the authoring environment, the player, or the application files. In particular embodiments, client system 1530 may include a Flash client. The Flash client may be configured to receive and run Flash application or game object code from any suitable networking system (such as, for example, social networking system 1520a or game networking system 1520b). In particular embodiments, the Flash client may be run in a browser client executed on client system 1530. A player can interact with Flash objects using client system 1530 and the Flash client. The Flash objects can represent a variety of in-game objects. Thus, the player may perform various in-game actions on various in-game objects by make various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1530, the Flash client may send the events that caused the game state changes to the in-game object to game networking system 1520b. However, to expedite the processing and hence the speed of the overall gaming experience, the Flash client may collect a batch of some number of events or updates into a batch file. The number of events or updates may be determined by the Flash client dynamically or determined by game networking system 1520b based on server loads or other factors. For example, client system 1530 may send a batch file to game networking system 1520b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1530. In particular embodiments, the batch file may be a text file and the name-value pairs may be in string format.

In particular embodiments, when a player plays an online game on client system 1530, game networking system 1520b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 1520b may retrieve the corresponding BLOB from the database to determine the most-recent values of the game-related data. In particular embodiments, while a player is playing the online game, game networking system 1520b may also load the corresponding BLOB into a memory cache so that the game system may have faster access to the BLOB and the game-related data contained therein.

### Example Network Systems

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

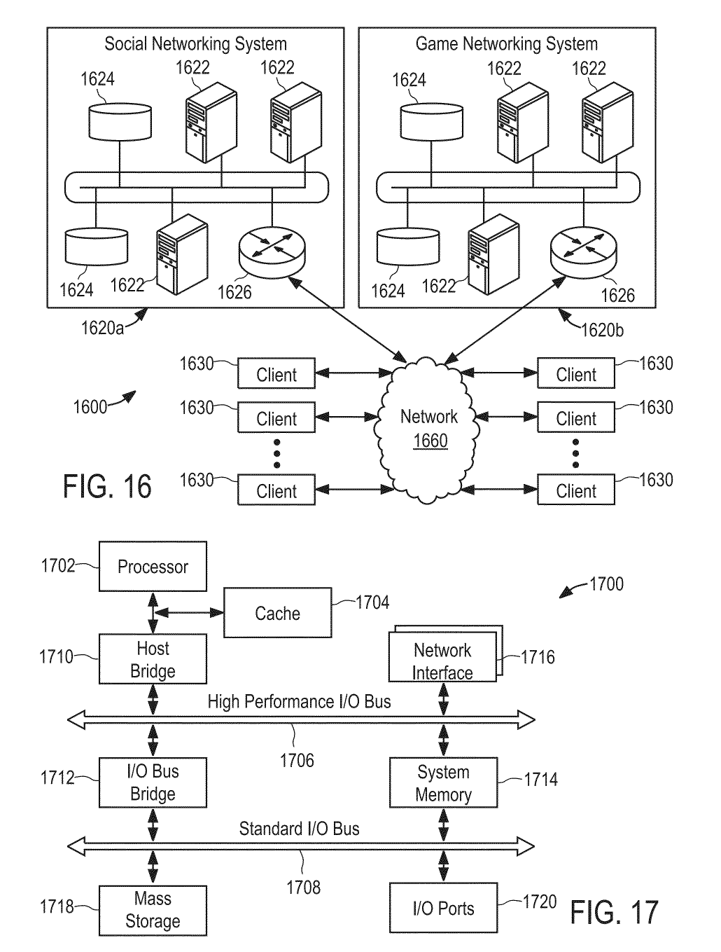

Particular embodiments may operate in a wide area network environment, such as the Internet, including multiple network addressable systems. FIG. 16 illustrates an example network environment, in which various example embodiments may operate. Network cloud 1660 generally represents one or more interconnected networks, over which the systems and hosts described herein can communicate. Network cloud 1660 may include packet-based wide area networks (such as the Internet), private networks, wireless networks, satellite networks, cellular networks, paging networks, and the like. As FIG. 16 illustrates, particular embodiments may operate in a network environment comprising one or more networking systems, such as social networking system 1620a, game networking system 1620b, and one or more client systems 1630. The components of social networking system 1620a and game networking system 1620b operate analogously; as such, hereinafter they may be referred to simply at networking system 1620. Client systems 1630 are operably connected to the network environment via a network service provider, a wireless carrier, or any other suitable means.

Networking system 1620 is a network addressable system that, in various example embodiments, comprises one or more physical servers 1622 and data stores 1624. The one or more physical servers 1622 are operably connected to computer network 1660 via, by way of example, a set of routers and/or networking switches 1626. In an example embodiment, the functionality hosted by the one or more physical servers 1622 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 1622 may host functionality directed to the operations of networking system 1620. Hereinafter servers 1622 may be referred to as server 1622, although server 1622 may include numerous servers hosting, for example, networking system 1620, as well as other content distribution servers, data stores, and databases. Data store 1624 may store content and data relating to, and enabling, operation of networking system 1620 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 1624 corresponds to one or more of a variety of separate and integrated databases, such as relational databases and object-oriented databases, that maintain information as an integrated collection of logically related records or files stored on one or more physical systems. Structurally, data store 1624 may generally include one or more of a large class of data storage and management systems. In particular embodiments, data store 1624 may be implemented by any suitable physical system(s) including components, such as one or more database servers, mass storage media, media library systems, storage area networks, data storage clouds, and the like. In one example embodiment, data store 1624 includes one or more servers, databases (e.g., MySQL), and/or data warehouses. Data store 1624 may include data associated with different networking system 1620 users and/or client systems 1630.

Client system 1630 is generally a computer or computing device including functionality for communicating (e.g., remotely) over a computer network. Client system 1630 may be a desktop computer, laptop computer, personal digital assistant (PDA), in- or out-of-car navigation system, smart phone or other cellular or mobile phone, or mobile gaming device, among other suitable computing devices. Client system 1630 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1630 to enter addresses of specific network resources to be retrieved, such as resources hosted by networking system 1620. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1630 desires to view a particular webpage (hereinafter also referred to as a target structured document) hosted by networking system 1620, the user's web browser, or other document rendering engine or suitable client application, formulates and transmits a request to networking system 1620. The request generally includes a URL or other document identifier as well as metadata or other information. By way of example, the request may include information identifying the user, such as a user ID, as well as information identifying or characterizing the web browser or operating system running on the user's client computing device 1630. The request may also include location information identifying a geographic location of the user's client system or a logical network location of the user's client system. The request may also include a timestamp identifying when the request was transmitted.

Although the example network environment described above and illustrated in FIG. 16 is described with respect to social networking system 1620a and game networking system 1620b, this disclosure encompasses any suitable network environment using any suitable systems. As an example and not by way of limitation, the network environment may include online media systems, online reviewing systems, online search engines, online advertising systems, or any combination of two or more such systems.

### Example Computer System

FIG. 17 illustrates an example computing system architecture, which may be used to implement a server 1622 or a client system 1630. In one embodiment, a hardware system 1700 comprises a processor 1702, a cache memory 1704, and one or more executable modules and drivers, stored on a tangible computer readable medium, directed to the functions described herein. Additionally, hardware system 1700 may include a high performance input/output (I/O) bus 1706 and a standard I/O bus 1708. A host bridge 1710 may couple processor 1702 to high performance I/O bus 1706, whereas I/O bus bridge 1712 couples the two buses 1706 and 1708 to each other. A system memory 1714 and one or more network/communication interfaces 1716 may couple to bus 1706. Hardware system 1700 may further include video memory (not shown) and a display device coupled to the video memory. Mass storage 1718 and I/O ports 1720 may couple to bus 1708. Hardware system 1700 may optionally include a keyboard, a pointing device, and a display device (not shown) coupled to bus 1708. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1700 are described in greater detail below. In particular, network interface 1716 provides communication between hardware system 1700 and any of a wide range of networks, such as an Ethernet (e.g., IEEE 802.3) network, a backplane, and so forth. Mass storage 1718 provides permanent storage for the data and programming instructions to perform the above-described functions implemented in servers 1622, whereas system memory 1714 (e.g., DRAM) provides temporary storage for the data and programming instructions when executed by processor 1702. I/O ports 1720 are one or more serial and/or parallel communication ports that provide communication between additional peripheral devices, which may be coupled to hardware system 1700.

Hardware system 1700 may include a variety of system architectures and various components of hardware system 1700 may be rearranged. For example, cache 1704 may be on-chip with processor 1702. Alternatively, cache 1704 and processor 1702 may be packed together as a “processor module,” with processor 1702 being referred to as the “processor core.” Furthermore, certain embodiments of the present disclosure may not require nor include all of the above components. For example, the peripheral devices shown coupled to standard I/O bus 1708 may couple to high performance I/O bus 1706. In addition, in some embodiments, only a single bus may exist, with the components of hardware system 1700 being coupled to the single bus. Furthermore, hardware system 1700 may include additional components, such as additional processors, storage devices, or memories.

An operating system manages and controls the operation of hardware system 1700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, and the like), that makes API calls directly to a server. Still further, while the embodiments described above operate with business-related virtual objects (such as stores and restaurants), the invention can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
receiving an enabling request for multiplayer functionality in a multiplayer instance that includes a single player mode game, the single player mode game involving a game board dedicated to a first player;
matching the single player mode game of the multiplayer instance with additional multiplayer instances, each additional multiplayer instance including a corresponding single player mode game dedicated to a respective player;
instructing, by one or more processors, the single player mode games from the multiplayer instance and the additional multiplayer instances to initiate gameplay at substantially the same time;
collecting final scores from the single player mode games from the multiplayer instance and the additional multiplayer instances; and
communicating a game summary page to the first player and the respective players.

2. The computer-implemented method of claim 1, further comprising, during gameplay of the single player mode game and the corresponding single player mode games:
receiving updates from the multiplayer instance, each update including a current score from the single player mode game; and
distributing the updates to the additional multiplayer instances.

3. The computer-implemented method of claim 2, wherein the updates are communicated via an event mechanism.

4. The computer-implemented method of claim 1, wherein the matching operates by selecting the additional multiplayer instances on behalf of the first player.

5. The computer-implemented method of claim 1, wherein the matching operates by selecting the additional multiplayer instances based on selections of the respective players made by the first player.

6. The computer-implemented method of claim 1, further comprising displaying the multiplayer instance on a client device associated with the first player, the display of the multiplayer instance presenting a game area representing the single player mode game and status modules correspond to the respective players, the status modules presenting current scores for the respective players during gameplay.

7. The computer-implemented method of claim 6, wherein the display of the multiplayer instance further includes a countdown prior to the initiation of gameplay.

8. A computer system, comprising:
at least one processor; and
a multiplayer library implemented by the at least one processor and configured to:
receive an enabling request for multiplayer functionality in a multiplayer instance that includes a single player mode game, the single player mode game involving a game board dedicated to a first player;
match the single player mode game of the multiplayer instance with additional multiplayer instances, each additional multiplayer instance including a corresponding single player mode game dedicated to a respective player;
instruct the single player mode games from the multiplayer instance and the additional multiplayer instances to initiate gameplay at substantially the same time;
collect final scores from the single player mode games from the multiplayer instance and the additional multiplayer instances; and
communicate a game summary page to the first player and the respective players.

9. The computer system of claim 8, wherein the multiplayer library is further configured to, during gameplay of the single player mode game and the corresponding single player mode games:
receive updates from the multiplayer instance, each update including a current score from the single player mode game; and
distribute the updates to the additional multiplayer instances.

10. The computer system of claim 9, wherein the updates are communicated via an event mechanism.

11. The computer system of claim 8, wherein the matching operates by selecting the additional multiplayer instances on behalf of the first player.

12. The computer system of claim 8, wherein the matching operates by selecting the additional multiplayer instances based on selections of the respective players made by the first player.

13. The computer system of claim 8, wherein the multiplayer library is further configured to display the multiplayer instance on a client device associated with the first player, the display of the multiplayer instance presenting a game area representing the single player mode game and status modules correspond to the respective players, the status modules presenting current scores for the respective players during gameplay.

14. The computer system of claim 13, wherein the display of the multiplayer instance further includes a countdown prior to the initiation of gameplay.

15. A non-transitory computer-readable medium storing executable instructions thereon, which, when executed by a processor, cause the processor to perform operations comprising:
receiving an enabling request for multiplayer functionality in a multiplayer instance that includes a single player mode game, the single player mode game involving a game board dedicated to a first player;
matching the single player mode game of the multiplayer instance with additional multiplayer instances, each additional multiplayer instance including a corresponding single player mode game dedicated to a respective player;
instructing the single player mode games from the multiplayer instance and the additional multiplayer instances to initiate gameplay at substantially the same time;
collecting final scores from the single player mode games from the multiplayer instance and the additional multiplayer instances; and
communicating a game summary page to the first player and the respective players.

16. The non-transitory computer-readable medium of claim 15, further comprising, during gameplay of the single player mode game and the corresponding single player mode games:
receiving updates from the multiplayer instance, each update including a current score from the single player mode game; and
distributing the updates to the additional multiplayer instances.

17. The non-transitory computer-readable medium of claim 16, wherein the updates are communicated via an event mechanism.

18. The non-transitory computer-readable medium of claim 15, wherein the matching operates by selecting the additional multiplayer instances on behalf of the first player.

19. The non-transitory computer-readable medium of claim 15, wherein the matching operates by selecting the additional multiplayer instances based on selections of the respective players made by the first player.

20. The non-transitory computer-readable medium of claim 15, further comprising displaying the multiplayer instance on a client device associated with the first player, the display of the multiplayer instance presenting a game area representing the single player mode game and status modules correspond to the respective players, the status modules presenting current scores for the respective players during gameplay.
